(19) United States
(12) Patent Application Publication
(10) Pub. No.: US 2008/0106526 A1
(43) Pub. Date: May 8, 2008

(54) TOUCH ON-SCREEN DISPLAY CONTROL DEVICE AND CONTROL METHOD THEREFOR AND LIQUID CRYSTAL DISPLAY

(75) Inventor: Sheng-Wei Chen, Chung Ho City (TW)

Correspondence Address: RABIN & Berdo, PC, 1101 14TH STREET, NW, SUITE 500, WASHINGTON, DC, 20005, US

(73) Assignee: AmTRAN TECHNOLOGY CO., LTD., Taipei (TW)

(21) Appl. No.: 11/671,658

(22) Filed: Feb. 6, 2007

(30) Foreign Application Priority Data
Nov. 8, 2006 (TW) 095141399

(51) Int. Cl. G06F 3/041; G09G 5/00

(52) U.S. Cl. 345/174; 345/204; 345/173; 178/18.03

(57) ABSTRACT

A touch on-screen display (OSD) control device and a control method therefor and a liquid crystal display (LCD) are provided, wherein a sensing control module and a display control module disposed on the LCD are used to sense and analyze a user's operations, so as to enable the user to adjust a display state of the LCD by a touch operation mode, and an adjusted frame is displayed on a display module of the LCD, thereby enhancing an operation convenience.

### CROSS-REFERENCE TO RELATED APPLICATIONS

This non-provisional application claims priority under 35 U.S.C. § 119(a) on Patent Application No(s). 095141399 filed in Taiwan, R.O.C. on Nov. 8, 2006, the entire contents of which are hereby incorporated by reference.

### BACKGROUND OF THE INVENTION

1. Field of Invention

The present invention relates to a display control device and a display state control method therefor, and more particularly to a touch on-screen display (OSD) control device and a control method therefor and a liquid crystal display (LCD).

2. Related Art

As the progress of optoelectronic science and technology, the current mainstream of displays has gradually switched from a cathode-ray tube (CRT) display to an LCD and a plasma display panel (PDP). Thus, the display quality is improved. Besides, the LCD or PDP is more preferable than the CRT display in terms of volume, weight, size, and appearance. To enable a user to freely adjust display parameter values (for example, frame brightness, frame, frame contrast, frame size, frame position, or horizontal/vertical scanning frequency) of a display, most displays have an OSD function, wherein a ON/OFF button and a plurality of adjusting buttons are disposed on the shell of the display for the user to adjust the display parameter values of the display. The ON/OFF button is used for turning on or off the display. The adjusting buttons are used for calling an OSD set menu and adjusting the display parameter values of the display. However, the above push-button structure has the problem of mechanical noises, and each button must be labeled with the corresponding graphic symbol for indicating the function of the button to the user, which still needs some improvements in the operation convenience.

With reference to Taiwan Patent Publication No. 1252689, the patent discloses an OSD method for providing audio warning. After the initialization process, the following steps are performed: (A) determining whether an OSD is called or not; (B) adjusting the parameters; (C) determining whether the adjustment of the parameters should be accepted or not, and if not, a second audio is played immediately; (D) playing a first sound effect, and (E) updating the parameters.

Although the above patent enables the user to alter the set values or reminds the user by audios when an operation error occurs, which makes the OSD operation become more vivid and humane, it is still not perfect in enhancing the operation convenience.

Therefore, at present, most LCDs adopt the push-button operation to adjust the display state set values, which not only makes annoying mechanical noises, but also requires to be provided with a plurality of buttons with indicating symbols corresponding to the required operation functions, which needs to be improved in appearance and feeling designs.

### SUMMARY OF THE INVENTION

In view of the above problems, the present invention is directed to providing a touch OSD control device and a control method therefor and an LCD. The touch operation mode makes no mechanical noises, and is better than the push-button operation mode in product appearance and operation convenience.

The touch OSD control device provided by the present invention comprises a sensing control module and a display control module.

When the user touches the sensing control module having a touch sensing area, the sensing control module generates a sensing signal corresponding to the triggered position in the touch sensing area to the display control module. Then, the display control module displays an OSD set menu on the LCD.

Therefore, the touch OSD LCD provided by the present invention comprises a sensing control module, a display control module, and a display module.

When the user touches the sensing control module having a touch sensing area, the sensing control module generates a sensing signal corresponding to the triggered position in the touch sensing area to the display control module. Then, the display control module displays an OSD set menu on the LCD, and analyzes an operation instruction corresponding to the sensing signal to generate a control signal corresponding to the operation instruction to the display module, so as to make the display module display an adjusted frame.

After the OSD set menu is triggered to be displayed, if the touch sensing area does not sense any triggering operation again within a predetermined time period, the display control module automatically turns down the OSD set menu, thereby improving the operation convenience.

Furthermore, according to the LCD display state control method provided by the present invention, a touch sensing area is disposed on the LCD to enable the user to adjust the display state of the LCD by a touch operation mode. The method comprises: first, displaying an OSD set menu on the LCD, if the touch sensing area senses a triggering operation; next, analyzing an operation instruction corresponding to the triggered position in the touch sensing area; performing adjustment operations of an OK option, cancel option, alteration option, or alteration set value in the OSD set menu according to the operation instruction, and using a display effect to indicate the selected option in the OSD set menu; and finally, displaying an adjusted frame.

Through the touch OSD control device and the control method therefor and the LCD, as the touch sensor is characterized in being smoothly integrated with the shell of the LCD, the present invention is more preferred than the original LCD in the aesthetic feeling of the appearance. Besides, unlike the push-button structure, the present invention makes no mechanical noises in operation. Moreover, each display state set value can be adjusted by directly touching the touch sensing area by a finger or by a sliding operation, which is also preferred than the push-button operation mode in terms of operation convenience.

The features and practice of preferred embodiments of the present invention will be illustrated below in detail with reference to the accompanying drawings.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, which thus is not limitative of the present invention, and wherein:

FIG. 1 is a system block diagram of an embodiment of the present invention;

FIG. 2 is a schematic circuit diagram of a sensing control module according to an embodiment of the present invention; and

FIG. 3 is a flow chart of a method of an embodiment of the present invention.

### DETAILED DESCRIPTION OF THE INVENTION

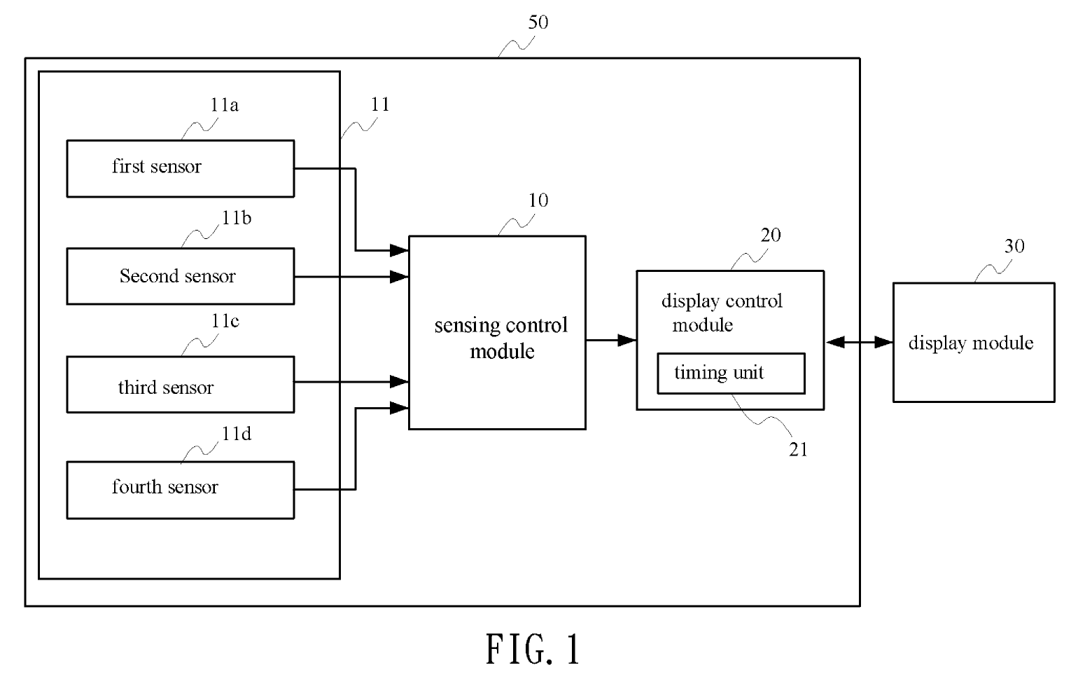

Referring to FIG. 1, it is a system block diagram of an embodiment of the present invention. As shown in FIG. 1, the touch OSD LCD of the present invention includes a sensing control module 10, a display control module 20, and a display module 30, wherein the sensing control module 10 and the display control module 20 constitute a control device 50. The above modules are respectively illustrated below.

The sensing control module 10 includes a plurality of sensors (a first sensor 11a, a second sensor 11b, a third sensor 11c, and a fourth sensor 11d respectively), which constitute a touch sensing area 11, and they are preferably arranged in a straight line or in a circle. In practice, the sensors can be, for example, resistive sensors, infrared sensors, capacitive touch sensors, or surface acoustic wave sensors, and the capacitive touch sensor is preferred. In addition, the number of sensors in this embodiment is taken as an example for illustration, but not to limit the applicable number of the sensors.

When the user touches the touch sensing area 11, the sensing control module 10 generates a sensing signal corresponding to the triggered position in the touch sensing area 11. The type of the sensing signal can be classified into a single sensing signal and a directional sensing signal. The single sensing signal represents that the user touches any one of the first sensor 11a, the second sensor 11b, the third sensor 11c, or the fourth sensor 11d; whereas the directional sensing signal represents that the user touches any one of the first sensor 11a, the second sensor 11b, the third sensor 11c, or the fourth sensor 11d and then touches the next adjacent sensor, so as to form a directional touch (for example, sliding leftwards or rightwards).

Moreover, the sensing control module 10 of this embodiment further provides a function of precisely determining the triggered position. When the touch sensing area 11 senses two or more triggered positions simultaneously, the sensing control module 10 only generates a sensing signal corresponding to the triggered position with the strongest signal, which is mainly achieved by comparing the strength of the signal sensed by each sensor and omitting the sensors whose signals are weaker than that of the strongest one, thus enhancing the touch sensing precision.

The display control module 20 is connected to the sensing control module 10, for displaying an OSD set menu on the LCD upon receiving the sensing signal. Next, the display control module 20 analyzes an operation instruction corresponding to the sensing signal, generates a control signal corresponding to the operation instruction, and then outputs the control signal to the display module 30, so as to perform the adjustment operation of an OK option, a cancel option, an alteration option, or an set value alteration option (for example, color set value, contrast set value, brightness set value, sound set value, frame horizontal set value, or frame vertical set value) in the OSD set menu. The type of the sensing signal corresponding to the OK option and the cancel option is a single sensing signal. The type of the sensing signal corresponding to the alteration option and the set value alteration option is a directional sensing signal, so the adjustment operations of the alteration option and the set value alteration option are performed in a direction along which the touch sensing area is triggered. Furthermore, the display control module 20 can be, for example, a microprocessor control unit (MCU) in practice.

The display control module 20 further includes a timing unit 21 for starting timing for a predetermined time period upon receiving the sensing signal. If the touch sensing area 11 does not sense any triggering operation again during the predetermined time period, the display control module 20 shuts down the OSD set menu; on the other aspect, if the touch sensing area 11 senses a triggering operation again during the predetermined time period, the display control module 20 continues to display the OSD set menu on the LCD, and the timing unit 21 starts timing for another predetermined time period.

The display module 30 is connected to the display control module 20, for receiving the control signal of the display control module 20 to display an adjusted frame. In practice, the display module 30 includes a liquid crystal panel and a back light module. Furthermore, an LCD is taken as an example for illustration in this embodiment. Those skilled in the art may replace the display module 30 with a PDP module or CRT display module, which still falls within the scope of the present invention.

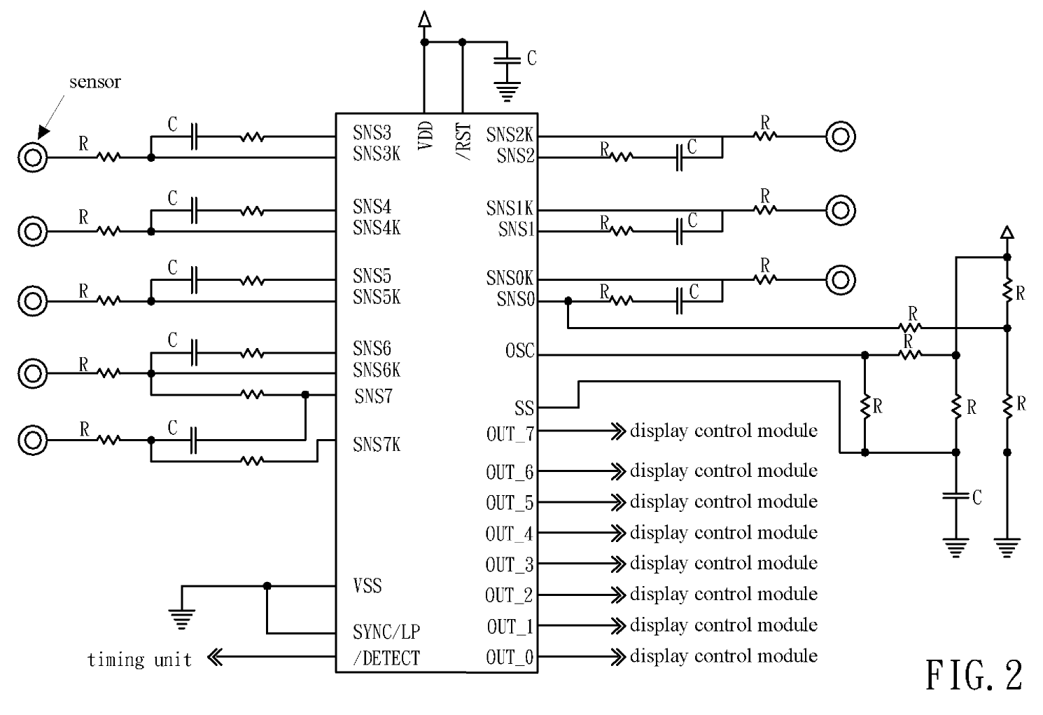

Referring to FIG. 2, it is a schematic circuit diagram of a sensing control module according to an embodiment of the present invention. The sensing control module 10 in FIG. 2 has eight sensors respectively connected to a signal input terminal of a signal control integrated circuit (IC) through a serial/parallel loop of a resistor R and a capacitor C, and the sensing signal is output from a signal output terminal to the display control module 20. A /DETECT pin is connected to the timing unit 21 of the display control module 20 for triggering a timing mechanism. The pins of the signal control IC can be classified into the following types: (1) sensing signal input terminals: SNS0, SNS0K, SNS1, SNS1K, SNS2, SNS2K, SNS3, SNS3K, SNS4, SNS4K, SNS5, SNS5K, SNS6, SNS6K, SNS7, and SNS7K; (2) signal output terminals: OUT_0, OUT_1, OUT_2, OUT_3, OUT_4, OUT_5, OUT_6, and OUT_7; (3) signal reset input terminal: /RST; (4) power supply terminals: VDD, VSS; (5) timing frequency input terminal: OSC; (6) spread spectrum output terminal: SS; (7) signal synchronous input terminal: SYNC/LP; (8) sensing state output terminal: /DETEC.

After receiving the sensing signal, the display control module 20 performs an analysis operation to determine an operation instruction to be implemented, and transmits a control signal corresponding to the operation instruction to the display module 30, so as to control the display state of the control display module 30, thus achieving the adjustment operation of the display.

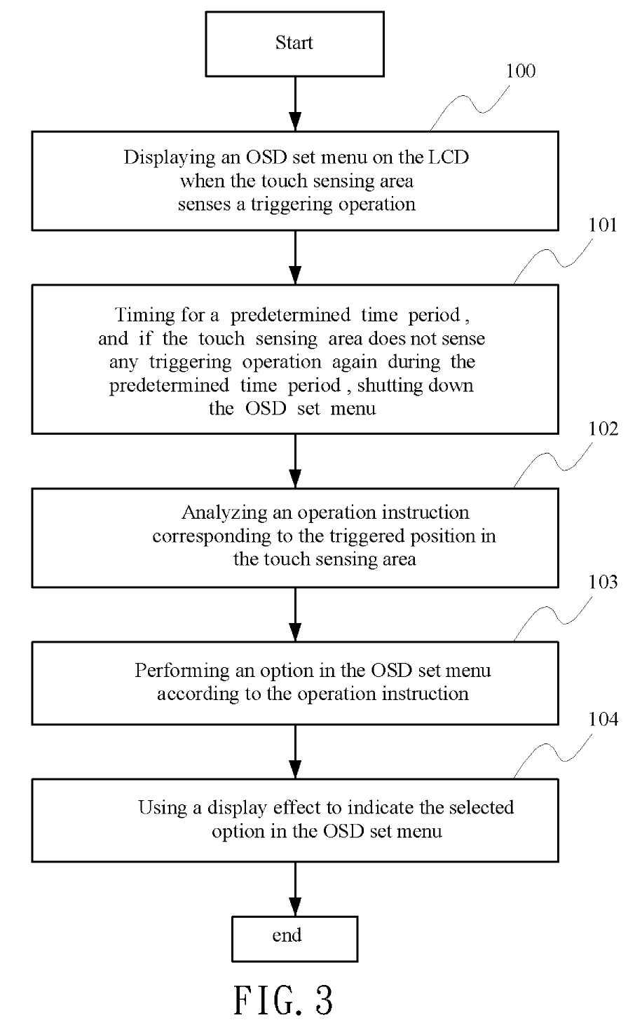

Referring to FIG. 3, it is a flow chart of a method of an embodiment of the present invention. As shown in FIG. 3, the method for controlling an LCD display state of the present invention includes the following steps.

First, when the touch sensing area senses a triggering operation, the sensing control module 10 generates a sensing signal to the display control module 20, and the display control module 20 then calls and displays an OSD set menu on the LCD (Step 100). Upon receiving the sensing signal, the timing unit 21 starts timing for a predetermined time period, and if the touch sensing area does not sense any triggering operation again during the predetermined time period, i.e., the timing unit does not receive any sensing signal during the predetermined time period, the display control module 20 is informed to shut down the OSD set menu (Step 101).

Next, the display control module 20 analyzes an operation instruction corresponding to the triggered position in the touch sensing area according to the sensing signal (Step 102), wherein the operation instruction corresponding to the OK option, the cancel option, the alteration option, or the set value alteration option (for example, color set value, contrast set value, brightness set value, sound set value, frame horizontal set value, or frame vertical set value) is performed according to the sensing signal type (for example, single sensing signal or directional sensing signal); then, the display control module 20 outputs a corresponding control signal to the display module 30 according to the operation instruction, for performing the adjustment operation of the OK option, the cancel option, the alteration option, or the set value alteration option in the OSD set menu (Step 103).

The selected option in the OSD set menu is indicated by a display effect (for example, inverse display effect) (Step 104), so as to enable the user to identify the selected option, and the display module 30 displays an adjusted frame.

Through the touch OSD control device and the control method therefor and the LCD, as the touch sensor has a feature of being smoothly combined with the shell of the LCD, the present invention is more preferred than the original LCD in the aesthetic feeling of the appearance. Besides, unlike the push-button structure, the present invention makes no mechanical noises in operation. Moreover, each display state set value can be adjusted by directly touching the touch sensing area by a finger or by a sliding operation, which is also preferred than the push-button operation mode in terms of operation convenience.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A touch on-screen display (OSD) control device, comprising:
a sensing control module, having a plurality of sensors that constitutes a touch sensing area, and generating a sensing signal corresponding to a triggered position in the touch sensing area; and
a display control module, connected to the sensing control module, for displaying an OSD set menu on a liquid crystal display (LCD) upon receiving the sensing signal, and analyzing the sensing signal to generate a control signal, so as to perform an option in the OSD set menu according to the control signal.

2. The touch OSD control device as claimed in claim 1, wherein the display control module further comprises a timing unit for starting timing for a predetermined time period upon receiving the sensing signal, and if the touch sensing area does not sense any triggering operation again during the predetermined time period, the display control module shuts down the OSD set menu.

3. The touch OSD control device as claimed in claim 1, wherein the option is corresponding to an adjustment operation of an OK option, a cancel option, an alteration option, or a set value alteration option.

4. The touch OSD control device as claimed in claim 3, wherein the adjustment operations of the alteration option and the set value alteration option are performed in a direction along which the touch sensing area is triggered.

5. The touch OSD control device as claimed in claim 1, wherein when the touch sensing area senses two or more triggered positions simultaneously, the sensing control module only generates a sensing signal corresponding to the triggered position with strongest signal.

6. The touch OSD control device as claimed in claim 1, wherein the sensors are capacitive touch sensors.

7. A method for controlling a liquid crystal display's (LCD) display state, wherein a touch sensing area is disposed on the LCD for a user to touch and adjust the display state of the LCD, the method comprising:
displaying an on-screen display (OSD) set menu on the LCD, when the touch sensing area senses a triggering operation;
analyzing an operation instruction corresponding to a triggered position in the touch sensing area;
performing an option in the OSD set menu according to the operation instruction; and
using a display effect to indicate a selected option in the OSD set menu.

8. The method for controlling the LCD's display state as claimed in claim 7, wherein after the step of displaying an OSD set menu on the LCD when the touch sensing area senses a triggering operation, a step of timing for a predetermined time period and if the touch sensing area does not sense any triggering operation again during the predetermined time period, the OSD set menu is shut down.

9. The method for controlling the LCD's display state as claimed in claim 7, wherein the option is corresponding to an adjustment operation of an OK option, a cancel option, an alteration option, or a set value alteration option.

10. The method for controlling the LCD's display state as claimed in claim 9, wherein the set value alteration option comprises a color set value, a contrast set value, a brightness set value, a sound set value, a frame horizontal set value, and a frame vertical set value.

11. The method for controlling the LCD's display state as claimed in claim 9, wherein the adjustment operations of the alteration option and the set value alteration option are performed in a direction along which the touch sensing area is triggered.

12. The method for controlling the LCD's display state as claimed in claim 7, wherein the display effect is an inverse display effect.

13. A touch on-screen display (OSD) of liquid crystal display (LCD), comprising:
a sensing control module, having a plurality of sensors that constitutes a touch sensing area, and generating a sensing signal corresponding to a triggered position in the touch sensing area;
a display control module, connected to the sensing control module, for displaying an OSD set menu on the LCD upon receiving the sensing signal, and analyzing the sensing signal to generate a control signal, so as to perform an option in the OSD set menu according to the control signal; and
a display module, connected to the display control module, for displaying an adjusted frame.

14. The touch OSD of LCD as claimed in claim 13, wherein the display control module further comprises a timing unit, for starting timing for a predetermined time period upon receiving the sensing signal, and if the touch sensing area does not sense any triggering operation again during the predetermined time period, the display control module shuts down the OSD set menu.

15. The touch OSD of LCD as claimed in claim 13, wherein the option is corresponding to an adjustment operation of an OK option, a cancel option, an alteration option, or a set value alteration option.

16. The touch OSD of LCD as claimed in claim 15, wherein the adjustment operations of the alteration option and the set value alteration option are performed in a direction along which the touch sensing area is triggered.

17. The touch OSD of LCD as claimed in claim 13, wherein when the touch sensing area senses two or more triggered positions simultaneously, the sensing control module only generates a sensing signal corresponding to the triggered position with strongest signal.

18. The touch OSD of LCD as claimed in claim 13, wherein the sensors are capacitive touch sensors.
